(19) United States
(12) Patent Application Publication
(10) Pub. No.: US 2009/0000502 A1
(43) Pub. Date: Jan. 1, 2009

(54) METHOD AND DEVICE FOR BLANKET WASH-UP OF A PRINTING COUPLE OF A ROTARY PRINTING PRESS

(75) Inventors: Ralf SCHAEDLICH, Plauen (DE); Klaus Toepfer, Muehltroff (DE)

Correspondence Address: CROWELL & MORING LLP;INTELLECTUAL PROPERTY GROUP, P.O. BOX 14300, WASHINGTON, DC, 20044-4300, US

(73) Assignee: manroland AG, Offenbach/Main (DE)

(21) Appl. No.: 12/145,357

(22) Filed: Jun. 24, 2008

(30) Foreign Application Priority Data
Jun. 26, 2007 (DE) 10 2007 029 550.4

(51) Int. Cl. B41F 35/00

(52) U.S. Cl. 101/425; 101/483

(57) ABSTRACT

A method and device for blanket wash-up in the case of a printing couple of a rotary printing press, is disclosed. In order to wash up blankets, blanket plates or blanket sleeves on blanket printing cylinders in a time-saving and cost-effective manner by a blanket wash-up device, during delivery wash-up with paper, a separation of the paper web speed from the circumferential speed of the blanket printing cylinder is realized. As a result, it is possible to realize a high rotational speed of the blanket printing cylinder and therefore a high relative speed at the wash-up location with high water usage while only small amounts of paper are used.

This application claims the priority of German Patent Document No. 10 2007 029 550.4, filed Jun. 26, 2007, the disclosure of which is expressly incorporated by reference herein.

### BACKGROUND AND SUMMARY OF THE INVENTION

The invention relates to blanket wash-up in the case of a printing couple of a rotary printing press, and in particular a method and device for washing up, with paper, a cover, such as a blanket, a blanket plate (MBB=metal back blanket) or a blanket sleeve, that is located on a blanket printing cylinder of a printing couple of a rotary printing press as well as a printing couple of a rotary printing press that is equipped with such a device.

Different types of wash-up devices are known for washing up a cover, such as a blanket, a blanket plate or a blanket sleeve, that is located on a blanket printing cylinder. These types of wash-up devices differ in terms of their mode of operation at the wash-up location, their arrangement in the printing couple of the rotary printing press (hereinafter simply printing press) and their wash-up position in relation to the “impression on” or “impression off” state.

In terms of the mode of operation, essentially systems with a rotating brush, changing brush, cloth or wash-up sock are known. In terms of the arrangement of the printing press in the printing couple, single wash-up devices for cylinders (permanently assigned to one cylinder or rotatably arranged and acting on two cylinders in succession) or double wash-up devices, which act on two cylinders simultaneously, are known. With respect to the relation to the “impression on” or “impression off” state during wash-up, systems that operate only in the “impression off” state are represented in particular in newspaper production.

For the wash-up of a cover located on a blanket cylinder, three categories are differentiated with respect to the wash-up logic: the final wash-up of the blankets without paper, delivery wash-up of the blankets with paper and production wash-up of the blankets with paper.

Delivery wash-up with paper represents an effective form of cleaning because the paper or the paper web can be left in the printing press and therefore webbing up the paper web again is not required in order to continue production or to run a similar production. During delivery wash-up with paper, the printing press is normally brought from the production speed to the webbing-up speed, wherein, during this process, the “impression off” state is reached. The wash-up of the cover of the blanket printing cylinder, such as the blanket, the blanket plate or the blanket sleeve, is then carried out at the webbing-up speed, wherein the paper web speed and the cylinder circumferential speed are identical.

Essentially two substances are used for the wash-up of a cover located on a blanket printing cylinder, namely water and blanket washing agent. In this case, water plays the decisive role in cleaning the cover of paper lint. The blanket washing agent acts essentially against the build-up of ink.

In the case of extensive build-up of paper lint, particularly the quantity of the applied water or the duration of the wash-up process must be increased in order to realize the cleaning of paper lint. Applying water to the cover of the blanket printing cylinder in the case of wash-up with paper always represents a substantial source of danger since web breaks can occur because water significantly reduces the strength of the paper web.

The invention is based on the objective of making available a method and a device for washing up, with paper, a cover, such as a blanket, a blanket plate or a blanket sleeve, that is located on a blanket printing cylinder of a printing couple of a rotary printing press, as well as making available a printing couple of a rotary printing press equipped with such a device, with which an effective, quick and production-safe delivery wash-up of a blanket printing cylinder can be realized with the smallest amount of waste.

It was recognized in accordance with the invention that the effectiveness of the wash-up of a cover located on a blanket printing cylinder was significantly influenced by the surface speed or relative speed between the wash-up device and the blanket printing cylinder, wherein the higher the relative speed, the better the wash-up result and the shorter the wash-up time as well. The attainment in accordance with the invention achieves such a high relative speed between the blanket printing cylinder and the wash-up device.

In other words, operating the blanket printing cylinder at a circumferential speed that is considerably higher as compared to a paper web speed results in a more effective and therefore quicker cleaning of the cover of the blanket printing cylinder.

According to an embodiment of the invention, the blanket printing cylinder is operated at a circumferential speed, which is approximately 100% to approximately 500% greater than the paper web speed. In other words, according to an embodiment of the invention, the circumferential speed of the blanket printing cylinder is approximately two-fold to approximately six-fold of that of the paper web speed.

In this connection, it must be noted, however, that, independent of the concretely selected speed ratio, it is essential to the realization of the invention that, during wash-up of the cover, the circumferential speed of the blanket printing cylinder be considerably higher than the paper web speed. According to an embodiment of the invention, the wash-up device is operated with an excess of water.

In this context, an excess of water means that a quantity of water applied to the blanket printing cylinder per time unit can be considerably greater than a water quantity that could be applied to the blanket printing cylinder without risking a paper web break, if, as in the prior art, the paper web speed and the circumferential speed of the blanket printing cylinder were identical. In other words, a quantity of water is applied to the blanket printing cylinder that is considerably greater than a quantity of blanket washing agent or blanket cleaning agent that is used for wash-up.

Because of the high rotational speed of the blanket printing cylinder, the water applied thereto is uniformly distributed over it and water dripping off it is reliably avoided.

Because of the considerably greater quantity of water in accordance with the invention, the build-up of paper lint or of ink located on the blanket printing cylinder is reliably solubilized and reliably absorbed by the wash-up device, and a paper web break is safely avoided despite this.

According to an embodiment of the invention, during delivery wash-up at the slower paper web speed or the webbing-up speed, the paper is left in touch contact with the blanket printing cylinder. This reliably prevents the development of water edges in the region of the cylinder channel of the blanket printing cylinder. It was established in accordance with the invention that the blanket printing cylinder that is rotating more quickly has no negative impact on the paper web.

Because of the relatively low paper web speed, the waste that is incurred during wash-up is negligibly small, thereby reducing production costs and sparing the environment.

### BRIEF DESCRIPTION OF THE DRAWINGS

The invention will be described in detail in the following on the basis of a preferred embodiment making reference to the enclosed Figures.

FIG. 1 shows a schematic view of the preferred embodiment of the inventive device.

FIG. 2 shows a flow chart of a preferred embodiment of the invention method.

### DETAILED DESCRIPTION OF THE DRAWINGS

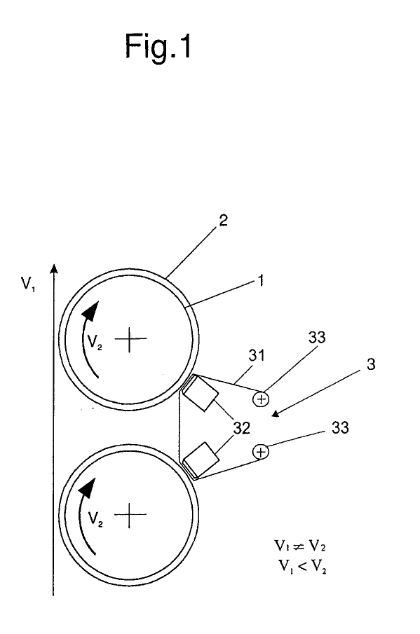

FIG. 1 shows an inventive device for washing up, with paper, a cover 2, such as a blanket, a blanket plate (MBB=metal back blanket) or a blanket sleeve, that is located on a blanket printing cylinder 1 of a printing couple of a rotary printing press.

As shown in FIG. 1, according to this embodiment of the invention, the printing couple of the rotary printing press has two blanket printing cylinders 1 with respective covers 2 and a wash-up device 3, which is set up for washing up the covers 2 of the blanket printing cylinders 1.

The wash-up device 3 is a type of wash-up device that operates with a wash-up cloth saturated with a blanket cleaning agent, like the devices sold by the company of BALDWIN® under the name of Impact Global®.

According to this embodiment of the invention, the wash-up device 3 has a wash-up cloth 31 saturated with blanket cleaning agent, two wash-up bars 32, two winding rollers 33 and a wash-up water feed device (not shown in FIG. 1). Each of the blanket printing cylinders 1 is assigned a wash-up bar 32 for its cleaning or washing up. The wash-up cloth 31 runs over both wash-up bars 32.

In other words, during wash-up, the clean wash-up cloth 31 is unwound from one of the two winding rollers 33, conveyed over both wash-up bars 32, which abut the respectively assigned blanket printing cylinder 1 during wash-up, and then the used section of the wash-up cloth 31 is wound onto the other of the two winding rollers 33.

The inventive device also has a control device (not shown in the figures) for controlling the wash-up of the covers 2 or the wash-up process. The control device has a command unit, such as, for example, a computer unit like a stored-program control, a cam arrangement or a cam, and a positioning device coupled with the command unit, e.g., control motors, pneumatic cylinders and switches, for attaining different states or settings of the rotary printing press, such an impression-on state, an impression-off state and certain cylinder rotational speeds.

A program for the wash-up process in the form of hardware, software or a combination thereof is stored or preset in the command unit.

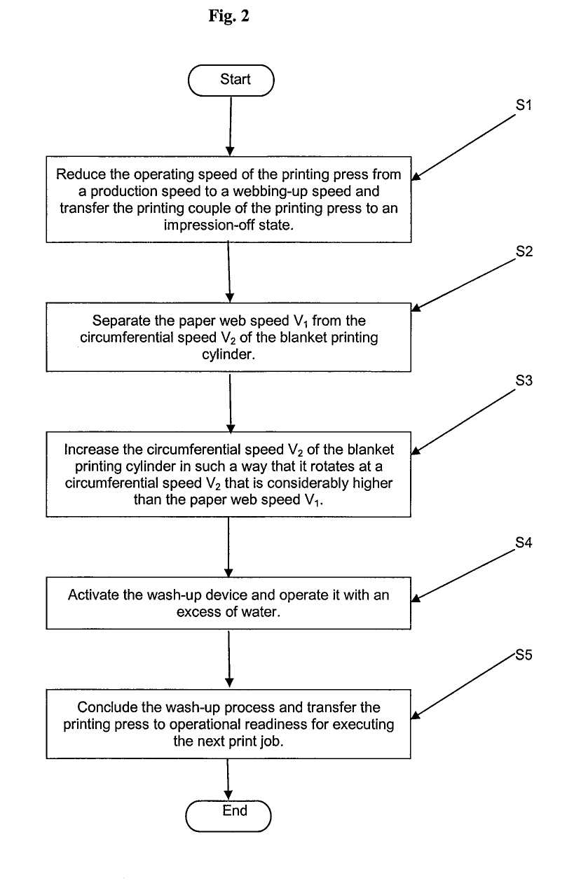

Now making reference to FIG. 1 and FIG. 2, the preferred embodiment of the inventive method for washing up, with paper, a cover 2, such as a blanket, a blanket plate or a blanket sleeve, that is located on a blanket printing cylinder 1 of a printing couple of a rotary printing press will be described.

When a delivery wash-up of the covers 2 of the blanket printing cylinders 1 must be carried out, an operator manually or automatically starts the wash-up process as a function of a predetermined parameter, such as reaching a specific unit number of a printed products or a specific number of operating hours. In this case, the paper web remains in the printing press, making it unnecessary to web up the paper web again to continue production after wash-up or to run a similar production.

During the wash-up process, the control device first reduces in a Step S1 the operating speed of the rotary printing press from a production speed to a webbing-up speed, wherein the circumferential speed V₂ of the blanket printing cylinders 1 and the paper web speed V₁ are reduced. According to an embodiment of the invention, the webbing-up speed is approximately 10 m/min. Depending upon the configuration of the printing press, higher or lower webbing-up speeds are possible, of course.

Furthermore, the control device transfers the printing couple of the rotary printing press in Step S1, i.e., during the reduction of the operating speed, to an impression-off state, wherein the paper web is left in touch contact with the blanket printing cylinders 1 and operated further at the webbing-up speed with 50% of the set paper web tension.

After reaching the slower webbing-up speed, the control device separates or decouples the paper web speed V₁ from the circumferential speed V₂ of the blanket printing cylinders 1 via programming measures or mechanically in a Step S2.

Afterwards, the control device again increases in a Step S3 the circumferential speed V₂ or the rotational speed of the blanket printing cylinders 1 in such a way that the blanket printing cylinders 1 rotate at a circumferential speed V₂ that is considerably higher as compared with the paper web speed V₁.

In other words, according to this embodiment of the invention, after Step S3, the paper web speed V₁ is approximately 10 m/min and the circumferential speed V₂ of the blanket printing cylinders 1 is approximately 60 m/min. In other words, according to this embodiment of the invention, the circumferential speed V₂ of the blanket printing cylinders 1 is approximately 500% greater than the paper web speed V₁ or is six-fold thereof. Depending upon the configuration of the printing press, other ratios of circumferential speed V₂ of the blanket printing cylinders 1 to the paper web speed V₁ are possible, of course.

Accordingly, the following applies to the paper web speed V₁ and the circumferential speed V₂ of the blanket printing cylinders 1:

V₁≠V₂ and V₁<V₂

After increasing the circumferential speed V₂ of the blanket printing cylinders 1 again, the control device activates the wash-up device 3 in a Step S4, wherein it operates the wash-up device 3 with an excess of water.

In this context, an excess of water means that a quantity of water applied to the blanket printing cylinder per time unit is considerably greater than a water quantity that could be applied to the blanket printing cylinder without risking a paper web break, if the paper web speed and the circumferential speed of the blanket printing cylinder were identical. In other words, a quantity of water is applied to the blanket printing cylinder that is considerably greater than a quantity of blanket washing agent or blanket cleaning agent that is used for wash-up.

After the lapsing of a specified wash-up time or after reaching a predetermined wash-up result, which can be recorded by means of sensors (not shown), the control device automatically concludes the wash-up process in a Step S5 so that the printing press is operationally ready for a subsequent print job. According to this embodiment, a wash-up time of approximate 2 minutes to approximately 4 minutes is specified.

As described above, in order to realize the washing up of covers 2, such as blankets, blanket plates or blanket sleeves, on blanket printing cylinders 1 by means of a blanket wash-up device 3 in a time-saving and cost-effective manner, during delivery wash-up with paper, a separation of the paper web speed V₁ from the circumferential speed V₂ of the blanket printing cylinder is realized. As a result, it is possible to realize a high rotational speed of the blanket printing cylinder 1 and therefore a high relative speed at the wash-up location (contact location of the blanket printing cylinder and the wash-up device) with high water usage while only small amounts of paper are used.

### LIST OF REFERENCE NUMERALS

1 Blanket printing cylinder
2 Cover
3 Wash-up device
31 Wash-up cloth
32 Wash-up bar
33 Winding roller
V₁ Paper web speed
V₂ Circumferential speed of the blanket printing cylinder

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for washing up, with paper, a cover, such as a blanket, a blanket plate or a blanket sleeve, that is located on a blanket printing cylinder of a printing couple of a rotary printing press, wherein, during a delivery wash-up of the cover, a circumferential speed of the blanket printing cylinder is considerably higher than a paper web speed.

2. The method according to claim 1, wherein, during the delivery wash-up, first an operating speed of the rotary printing press is reduced from a production speed to a webbing-up speed so that the circumferential speed of the blanket printing cylinder and the paper web speed reduce, and wherein the printing couple of the rotary printing press reaches an impression-off state during the reduction of the operating speed.

3. The method according to claim 2, wherein, after reaching the webbing-up speed, the paper web speed is separated from the circumferential speed of the blanket printing cylinder and then the circumferential speed of the blanket printing cylinder is increased again.

4. The method according to claim 3, wherein a wash-up device is activated after the circumferential speed of the blanket printing cylinder is again increased.

5. The method according to claim 4, wherein the wash-up device operates with an excess of water.

6. The method according to claim 2, wherein, during delivery wash-up, the paper is left in contact with the blanket printing cylinder.

7. A device for washing up, with paper, a cover, such as a blanket, a blanket plate or a blanket sleeve, that is located on a blanket printing cylinder of a printing couple of a rotary printing press, wherein the device comprises:
a wash-up device, which is set up for washing up the cover; and
a control device for controlling the wash-up of the cover coupled to the rotary printing press and the wash-up device, wherein the control device is set up in such a way that, during a delivery wash-up of the cover, the control device operates the blanket printing cylinder at a considerably higher circumferential speed as compared to a paper web speed.

8. The device according to claim 7, wherein the control device is set up in such a way that, during the delivery wash-up, it first reduces an operating speed of the rotary printing press from a production speed to a webbing-up speed, wherein the circumferential speed of the blanket printing cylinder and the paper web speed are reduced, and wherein the printing couple of the rotary printing press is transferred to an impression-off state during this reduction of the operating speed.

9. The device according to claim 8, wherein the control device is set up in such a way that, after reaching the webbing-up speed, it separates the paper web speed from the circumferential speed of the blanket printing cylinder and then again increases the circumferential speed of the blanket printing cylinder.

10. The device according to claim 9, wherein the control device is set up in such a way that, after again increasing the circumferential speed of the blanket printing cylinder, it activates the wash-up device.

11. The device according to claim 10, wherein the control device is set up in such a way that it operates the wash-up device with an excess of water.

12. The device according to claim 7, wherein the control device is set up in such a way that, during delivery wash-up, it leaves the paper in touch contact with the blanket printing cylinder.

13. A printing couple of a rotary printing press, with a device according to claim 7.

14. A method for washing up, with paper, a cover, on a blanket printing cylinder of a printing couple of a rotary printing press, comprising the steps of:
during a delivery wash-up of the cover, operating a circumferential speed of the blanket printing cylinder at a higher speed than a paper web speed.

15. The method according to claim 14, wherein the circumferential speed of the blanket printing cylinder is approximately 500% greater than the paper web speed.

16. The method according to claim 14, wherein, prior to the step of operating the circumferential speed of the blanket printing cylinder at a higher speed than the paper web speed, an operating speed of the rotary printing press is reduced from a production speed to a webbing-up speed such that the circumferential speed of the blanket printing cylinder and the paper web speed reduce, and the printing couple of the rotary printing press is transferred to an impression-off state during the reduction of the operating speed.

17. The method according to claim 16, wherein, after reaching the webbing-up speed, the paper web speed is separated from the circumferential speed of the blanket printing cylinder and then the circumferential speed of the blanket printing cylinder is increased again.

18. The method according to claim 17, further comprising the step of activating a wash-up device after the circumferential speed of the blanket printing cylinder is again increased.

19. The method according to claim 18, further comprising the step of operating the wash-up device with an excess of water.

20. The method according to claim 19, wherein the excess of water is a quantity of water that is applied to the blanket printing cylinder per time unit that is considerably greater than a water quantity that could be applied to the blanket printing cylinder without risking a paper web break if the paper web speed and the circumferential speed of the blanket printing cylinder were identical.
